(19) United States
(12) Patent Application Publication
(10) Pub. No.: US 2025/0248416 A1
(43) Pub. Date: Aug. 7, 2025

(54) PROCESS FOR PREPARING BISCUIT FILLINGS

(71) Applicant: Cargill, Incorporated, Wayzata, MN (US)

(72) Inventors: Tatiana Yasuoka BRADASCHIA, São Paulo (BR); Silmara Franco DE GODOY, Campinas (BR); Camila Cordeiro MANDU, Rotterdam (NL); Ana Carolina MARCUCCI, São Paulo (BR); Serpil METIN, Plymouth, MN (US); Rodolfo Lázaro Soares VIRIATO, São Paulo (BR); Fernanda ZACCARELLI DAVOLI, Plymouth, MN (US)

(21) Appl. No.: 18/856,237

(22) PCT Filed: Apr. 13, 2023
(86) PCT No.: PCT/US2023/018497

§ 371 Date: Oct. 11, 2024

Related U.S. Application Data
(60) Provisional application No. 63/331,192, filed on Apr. 14, 2022.
(60) Provisional application No. 63/331,196, filed on Apr. 14, 2022.
(60) Provisional application No. 63/331,200, filed on Apr. 14, 2022.

(51) Int. Cl. A23D 9/04; A21D 13/38; A23D 9/007

(52) U.S. Cl. CPC A23D 9/04; A21D 13/38; A23D 9/007

(57) ABSTRACT

Provided herein is a process for making a food product comprising the following steps: mixing a powdered fat with one or more other food ingredients other than liquid oil, and/or a fat composition different from liquid oil, applying shear, optionally adding liquid oil, and optionally applying shear. Preferably, the food product is a filling, topping, coating, or inclusion.

### CROSS-REFERENCE TO RELATED APPLICATIONS

This application claims the benefit of U.S. Provisional Application No. 63/331,200, filed Apr. 14, 2022, U.S. Provisional Application No. 63/331,196, filed Apr. 14, 2022, U.S. Provisional Application No. 63/331,192, filed Apr. 14, 2022, each of which are incorporated by reference herein in its entirety.

### BACKGROUND

Current practice to produce cookie, biscuit, cracker or wafer filling and/or topping and/or coating and apply it to the cookie, biscuit, cracker or wafer is labor intense. It is a high energy—consuming process). The filling and/or topping and/or coating has to be made and mixed (sheared) under warm temperature, then energy is necessary to cool down the cookie, then the warm filling has to be crystallized or solidified (cool down) after applied on the cookie. It is also a time-consuming process as it requires time for the filling to solidify under controlled temperature (cooling tunnel) before the product can be packaged.

### SUMMARY

Provided herein are novel methods of making a filling and/or topping and/or coating which will allow the manufacture of the filling to be done by a mixing and shearing step, such process is possible because of the physical structure of the powdered fat used to structure the fat phase of the filling and hold (stabilize) the liquid oil and other ingredients. With this new manufacturing process, one can by-pass or speed up the filling crystallization/solidification step. The new process also allows the production of fat filling with reduced saturated fatty acids, which align better with the dietary guidelines, by the addition of higher amounts of liquid oil when compared to the traditional cookie filling. The new manufacturing process leads to a cost advantage/increased savings. The type of raw material used to produce the powdered fat and the fat composition can also lead to a cost advantage potentially leading to an increase in savings.

Further advantages of the novel methods of making fillings or toppings or coatings are low in saturated fat, minimized or limited use of lecithin elimination or reduction of time required for cooling of—filling in cooling tunnel, less oil leaking or migration from the filling/toppings/coatings, cost competitive, providing the desired sensory experience, rheology and texture of a standardized filling/topping/coatings.

The current invention relates to a process for making a food product comprising the following steps:
a. mixing a powdered fat with one or more other food ingredients other than liquid oil, and/or fat composition different from liquid oil,
b. applying shear,
c. optionally adding liquid oil,
d. applying shear

It further relates to a process for making a biscuit filling, wafer filling, pie cookie filling, cracker filling or cookie filling comprising:
a) mixing of food ingredients other than fat and liquid oil, and/or optionally a fat composition and/or liquid oil
b) applying shear to mixture of step a); and
c) add optionally other food ingredients other than liquid oil to a) and apply shear
d) add a powdered fat to c) and apply shear
e) Repeat c) as needed

### DESCRIPTION OF THE INVENTION

Provided herein is a process for preparing a cookie filling, biscuit filling, cracker filling or wafer filling or topping or coating (e.g., sandwich cookies, pie cookies, extruded cookies, waffles, thumbprint cookies, Hamentaschen cookies, whoopie cookies, linzer cookies, macarons, and the like).

Conventional shortenings may contain high amounts of saturated fats to maintain its structure. It is well known that excessive consumption of saturated fats can lead to cardiovascular problems. Therefore, there is a drive to reduce the amount of saturated fat in the diet. Structuring fats by means of powdered fat particles, produced by fat atomization under supercritical CO2 conditions (as described in WO2020198585A1), allows a reduced consumption of saturated fat and an increased consumption of heart healthier unsaturated oils, because of its oil holding capacity, while keeping the functionality of a conventional shortening.

### Definitions

For the purposes of clarity and a concise description, features can be described herein as part of the same or separate embodiments; however, it will be appreciated that the scope of the invention may include embodiments having combinations of all or some of the features described.

As used herein, the indefinite articles “a”, “an” and “the” should be understood to include plural reference unless the context clearly indicates otherwise. Thus, for example, reference to “an inhibitor” refers to one or more agents with the ability to inhibit a target molecule, and reference to “the method” includes reference to equivalent steps and methods known to those skilled in the art, and so forth.

The phrase “and/or,” as used herein, should be understood to mean “either or both” of the elements so conjoined, e.g., elements that are conjunctively present in some cases and disjunctively present in other cases.

When separating a listing of items, “and/or” or “or” shall be interpreted as being inclusive, e.g., the inclusion of at least one, but also including more than one, of a number of items, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.”

As used herein, the term “about” means plus or minus 10% of the indicated value. For example, about 100 means from 90 to 110.

Where a range of values is provided, it is understood that each intervening value, between the upper and lower limit of that range and any other stated or intervening value in that stated range is encompassed within the invention. The upper and lower limits of these smaller ranges may independently be included in the smaller ranges, and are also encompassed within the invention, subject to any specifically excluded limit in the stated range. Where the stated range includes one or both of the limits, ranges excluding either both of those included limits are also included in the invention.

As used herein, the terms “including”, “includes”, “having”, “has”, or “with” are intended to be inclusive similar to the term “comprising.”

The terms “comprises,” “comprising,” and the like can have the meaning ascribed to them in U.S. Patent Law and can mean “includes,” “including” and the like. As used herein, “including” or “includes” or the like means including, without limitation.

Unless otherwise defined, all technical and scientific terms used herein have the same meaning as commonly understood by one of ordinary skill in the art to which the methods and compositions of matter belong. Although methods and materials similar or equivalent to those described herein can be used in the practice or testing of the methods and compositions of matter, suitable methods and materials are described below. In addition, the materials, methods, and examples are illustrative only and not intended to be limiting. All publications, patent applications, patents, and other references mentioned herein are incorporated by reference in their entirety.

It relates to a process for making a food product comprising the following steps:
a. mixing a powdered fat with one or more other food ingredients other than liquid oil, and/or fat composition different from liquid oil,
b. applying shear,
c. optionally adding liquid oil,
d. applying shear

### Food Product

The process of the present invention is suitable to make food products such as baked goods, baked goods that are filled and/or topped and/or coated and/or with added inclusions with a sweet and/or savory fat-based filling. Food inclusions are selected from ingredients that are added to a primary bakery or food product to enhance its taste, texture, appearance, or nutritional value, such as nuts, chocolates, cereals, crisps, caramels and the like. These inclusions can contain sweet and/or savory fat-based fillings. These inclusions may also be added into the sweet and/or savory fat-based fillings.

Baked goods are dough products as pie, waffles, cookies, cakes, rolls, biscuits, crackers, sandwich cookies, pie cookies, thumbprint cookies, Hamentaschen cookies, whoopie cookies, linzer cookies or macarons or snack bars. Cookies can be extruded cookies, rotary molded cookies, molded cookies oe laminated cookies and crackers.

The biscuit fillings described here are typically sweet and/or savory fat-based fillings, they can also be described (called) as toppings or coatings. The fillings described here can be found in sandwiched between biscuits, cookies, crackers, wafers, cakes, snack bars, or rolls. The fillings are, in general, added to an already baked product by spread on the surface or injection. A good filling should be easy to handle, stable (no phase separation or oil migration at room temperature). The fillings should have fine, smooth texture during storage and melt quickly in the mouth. The two main ingredients in traditional (standard) sweet fillings are sugar and fats/oils. Emulsifiers can be added to improve texture

The food product may be a filling, topping, coating, or inclusion.

The food product may be a biscuit filling, wafer filling, pie cookie filling, cracker filling or cookie filling.

### Powdered Fat

The powdered fat used herein is typically porous in structure and in powder form. The powdered fat particles are neat, and typically are spherical with open spongy structure. In other aspect the powdered fat can be seen as a foam like structure

The powdered fat used in the present invention is made as described in our earlier application (WO2020198585A1) by using a supercritical CO2 technology. The fat is either melted at a temperature ranging from at least about 5 to about 25 degrees above the melting temperature of the fat, and in some aspects at least about 5 to about 20 degrees above the melting temperature of the fat, and in other aspects at least about 5 to about 15 degrees above the melting temperature of the fat, and in yet other aspects at least about 5 to about 10 degrees above the melting temperature of the fat. The fat is then saturated with CO2 to obtain a mixture and such mixture is pressured at the CO2 triple point to achieve supercritical CO2. This causes the fat to be solubilized. This is then sprayed (atomized) causing the so-called crystallization, solidification, micronizing, atomization of the fat as the CO2 evaporates. This creates the powdered fat. This is typically done in a batch or semi-continuous process and the temperature is adjusted to that which is lower than the melting point of the fat to ensure the fat is in solid, powdered form.

The powdered fat is having a density ranging from 0.04 to 0.70 g/mL at room temperature, in some aspects from about 0.04 to 0.40 g/mL, or from about 0.05 g/mL to about 0.60 g/mL at room temperature, and in some aspects has a density ranging from 0.10 g/mL to about 0.50 g/mL at room temperature.

It shall be understood that reference to “density” herein means bulk density (also referenced as apparent density or volumetric density), which is a property of powders, granules, and other divided solids. It is defined as the mass of many particles divided by the total volume.

The physical structure of the powdered fat, characterized by its density range allows for a greater oil-holding capacity, unlike compacted fat structures. The powdered fat has an oil holding capacity of at least 5%, and in some aspects at least 10% and up to about 75%, and in some aspects up to about 80% of the weight of the fat. Oil holding capacity means that after adding the liquid oil to the powdered fat, no phase separation (oiling-off or oil migration) is observed, the liquid oil is held within the powdered fat structure by absorption, adsorption and/or entrainment phenomena.

The powdered fat used in the present invention is having a particle size ranging from 0.01 to 200 μm, preferably from 2.0 to 150 μm (microns).

The powdered fat also has a particle size distribution wherein at least 50%, in some aspects at least 60%, in some aspects of least 70%, in some aspects at least 80%, and in some aspects at least 90% (depending on the type of fat) of the particles have a particle size ranging from 2-150 microns, including 10-90 microns, 20-80 microns, 30-70 microns, 40-60 microns, 5 microns, 10 microns, 15 microns, 20 microns, 25 microns, 30 microns, 35 microns, 40 microns, 45 microns, 50 microns, 55 microns, 60 microns, 65 microns, 70 microns, 75 microns, 80 microns, 85 microns, 90 microns, 95 microns or 100 microns; in others, about 50% of particles have a size range from 10-80 microns, including 20-80 microns, 30-70 microns, 40-60 microns, 20 microns, 25 microns, 30 microns, 35 microns, 40 microns, 45 microns, 50 microns, 55 microns, 60 microns, 65 microns, 70 microns, 75 microns, or 80 microns.

In a further aspect of the invention, the used powdered fat does not comprise an emulsifier.

### Fat Composition

The fat composition is a single fat or a blend of fats and oils. They can be partially or fully crystallized. They can be supplied in different forms such as plasticized, pumpable and/or bulk. The fat composition may also include shortenings and/or oleogels. Shortenings and oleogels may contain structuring agents such as emulsifiers and/or vegetable waxes.

The fat composition may be derived from sunflower oil, corn oil, soybean oil, canola oil, rapeseed oil, cottonseed oil, rice bran oil, safflower oil, linseed oil, flaxseed oil, peanut oil, olive oil, tall oil, licuri oil, macadamia nut oil, its mid and high oleic versions, palm oil, shea butter, palm kernel oil, coconut oil, mango kernel oil, illipe oil, babassu oil, pequi oil, tallow, allanblackia oil, cocoa butter, nut oil, bacuri fat, cupuassu fat, ucuuba butter, macauba oil, macauba kernel oil, animal fat, dairy fat and their fractions, and their fully or partially hydrogenated and/or their interesterified version and combination thereof.

### Food Ingredients Other Than Liquid Oil

Food ingredients can be in powder, paste or liquid form. Food ingredients other than liquid oil can comprise additives, flavorings, colorings, thickening agents, sweetener-based ingredients (a substance used to sweeten food or drink, such as sugar, honey, glucose syrups, fructose syrups, maple syrup, agave nectar or other non-sugar sweeteners, such as saccharin, aspartame, cyclamates, steviol, and thaumatin and the like).

Thickening agents may comprise gums, such as, but not limited to, carrageenan, konjac gum, lotus bean gum, guar gum, alginate, pectin, gelatin or xanthan gum, vegetable fibers, maltodextrins, starches from various botanical sources, such as potato starch or maize starch, being in form of native starch, physically or chemically modified starch, or a mixture of two or more thereof.

Other ingredients suitable for the food product of interest may be added as well, such as flour, vegetable and/or animal proteins, milk solids, fruit powders, dried fruit, nuts, spices, seasonings, acids such as citric acid, chocolate, salt, cocoa liquor, cocoa powder, antioxidants and the like.

Food ingredients may also comprise emulsifiers. Emulsifiers can include food grade emulsifiers, including, but not limited to, lecithins, monoglycerides, diglycerides, polysorbates, propylene glycol esters, polyglycerol esters, acetic acid esters of mono and diglycerides, citric acid esters of mono and diglyceride, sucrose esters of fatty acid, sorbitan esters, polyglycerol polyricinoleate or lactic acid esters of mono and diglyceride or its combinations.

### Liquid Oil

The liquid oil is selected from the group consisting of sunflower oil, corn oil, soybean oil, canola oil, rapeseed oil, cottonseed oil, palm olein, palm super olein, rice bran oil, safflower oil, flaxseed oil, linseed oil, peanut oil, olive oil, tall oil, licuri oil, macadamia nut oil, their high oleic versions, their mid oleic, its high stearic versions, their fractions, corresponding interesterified oils, interesterified oil blends, and combinations of two or more thereof, provided the oil is liquid at 20° C. and at atmospheric pressure.

### Process of the Present Invention

The present invention relates to a process wherein the food product is a biscuit filling, wafer filling, pie cookie filling, cracker filling or cookie filling, and the process is comprising the following steps:
a) providing powdered fat;
b) mixing the powdered fat of a) with other food ingredients different from liquid oil, and/or optionally a fat composition;
c) applying shear to mixture of step b); and
d) optionally adding other food ingredients other than liquid oil to b) and/or optionally liquid oil to b) and
e) optionally apply shear.

The shear applied in the process of the present invention is ranging from 25 to 500 rpm, preferably from 100 to 200 rpm.

The present invention relates to a process wherein the food product is a biscuit filling, wafer filling, pie cookie filling, cracker filling or cookie filling, and the process is comprising the following steps:
a) providing powdered fat;
b) mixing the powdered fat of a) with other food ingredients selected from the group of sweeteners, spices, herbs, salt, bulking agents, fat composition and a combination of two or more thereof, and/or optionally a fat composition;
c) applying shear to mixture of step b); and
d) optionally adding other food ingredients other than liquid oil to b) and/or optionally liquid oil to b) and
e) optionally apply shear.

It relates to the process for making a filled biscuit, cookie, cracker or wafer comprising the following steps:
a) provide powdered fat;
b) mix the powdered fat of a) with sweetener and/or a fat composition;
c) applying shear to b); and
d) add optionally other food ingredients other than liquid oil to a) or b), and apply shear
e) Add liquid oil or fat composition to b) and apply shear
f) applying the filling/coating/topping of b), c) or d) to a first biscuit, cracker, cookie or wafer and optionally adding a second biscuit, cookie, cracker or wafer on top of the filling.

It relates to the process wherein the obtained food product is a filling that is applied to a first biscuit, cookie, cracker or wafer and optionally a second biscuit, cookie, cracker or wafer on top of the filling is added to make a filled biscuit, cookie, cracker or wafer.

It relates to the process wherein the steps of applying filling to a first biscuit, cookie, cracker or wafer and optionally adding a second biscuit, cookie, cracker or wafer on top of the filling is repeated several times, to have one or more biscuit, cookie, cracker or wafer layers and fillings in between a top and bottom biscuit, cookie, cracker or wafer.

It further relates to the process of the present invention for making the filling wherein sweeteners, salt, spices, bulking agents, powdered fat and/or optionally liquid oil and/or fat composition and/or other food ingredients are tempered at a temperature in the range of 10 to 60° C. or at a temperature of 20 to 50° C., and the process steps are carried out at this temper temperature.

The order of the steps can be changed, and the present invention relates to a process wherein the powdered fat is added as one of the last ingredients. It relates to a process for making a biscuit filling, wafer filling, pie cookie filling, cracker filling or cookie filling comprising the steps of:
a) mixing of food ingredients other than fat and liquid oil, and/or optionally a fat composition and/or liquid oil
b) applying shear to mixture of step a); and
c) add optionally other food ingredients other than liquid oil to a) and apply shear
d) add a powdered fat to c) and apply shear
e) Repeat c) as needed.

### EXAMPLES

### Analysis Methods

### Bulk Density of Powdered Fat

The bulk density (β) of the particles was determined using the tap method (Gudeman, Yang, and Ciftci 2019). Samples were filled into a 25 mL graduated cylinder and tapped slightly to avoid excess air between the particles. Then, the weight of the samples was recorded. The bulk density of the particles was calculated as: β=m/V (1) where, β is bulk density, m is weight of the sample, and V is volume of the sample.

### Particle Size/Particle Size Distribution

The particle size and size distribution of the samples were determined by laser diffraction method using a Mastersizer 3000 (Malvern Instruments Ltd., Worcestershire, UK). Samples (30 mg) were dispersed in 3% (w/w) polyoxyethylene sorbitan monooleate (Tween 80) in water and sonicated in an ultrasonic water bath (3510 R-MTH, Branson Ultrasonics Corporation, Danbury, CT, USA) for 30 min before each analysis. The refractive index (RI) of the sample was set as 1.46 while distilled water was 1.33. 2

### Example 1

Examples of powdered fat (see Table 1), and prepared as described in WO2020198585A1:

TABLE 1

| | | | Mean | Saturated |
|---|---|---|---|---|
| Powdered | Powdered fat | Density | particle | fat content |
| fat ID | composition | (g/ml) | size (μm) | (%) |
| B5 | 67% hydrogenated soybean | 0.044 | 12.4 | 71% |
| | fat + 33% soybean oil | | | |
| B8 | 75% hydrogenated soybean | 0.056 | 15.4 | 78% |
| | fat + 25% soybean oil | | | |
| S1 | Fully hydrogenated | 0.2 | 40 | 99% |
| | soybean fat | | | |

### Example 2

### Example of Biscuit Filling

Procedure, using the ingredients/recipe described in Table 2:
1. Weigh the powdered fat (described in Table 1)
2. Add sugar and fat composition to the powdered fat and apply shear at 100 rpm.
3. Add oil and mix (shear at 100 rpm) to make a filling.

TABLE 2

| | Biscuit | Biscuit | Biscuit |
|---|---|---|---|
| | filling made | filling made | filling made |
| | with powdered | with powdered | with powdered |
| Materials (g) | fat S1 | fat B5 | fat B8 |
| Powdered fat | 0.5 | 0.3 | 0.3 |
| Soybean oil | 1 | 1.2 | 1.2 |
| Total Fat phase | 1.5 | 1.5 | 1.5 |
| (powdered fat + | | | |
| soybean oil) | | | |
| Total Sugar | 3.5 | 3.5 | 3.5 |
| Filling | Firm filling | smooth firm | , firm filling |
| | | filling, | |

1. A process for making a food product comprising the following steps:
a. mixing a powdered fat with one or more other food ingredients other than liquid oil, and/or a fat composition different from liquid oil,
b. applying shear,
c. optionally adding liquid oil,
d. optionally applying shear.

2. The process of claim 1, wherein the one or more other food ingredients other than liquid oil are added as a powder, a paste or a liquid.

3. The process according to claim 1, wherein after step b) liquid oil is added to the mixture of powdered fat and the one or more other food ingredients, followed by applying shear.

4. The process according to claim 1, wherein the food product is a filling, topping, coating, or inclusion.

5. The process according to claim 1, wherein the food product is a biscuit filling, wafer filling, pie cookie filling, cracker filling or cookie filling.

6. The process according to claim 5 for making a biscuit filling, wafer filling, pie cookie filling, cracker filling or cookie filling comprising the following steps:
a) providing powdered fat;
b) mixing the powdered fat of a) with other food ingredients different from liquid oil, and/or optionally a fat composition;
c) applying shear to mixture of step b); and
d) adding optionally other food ingredients other than liquid oil to b) and/or optionally liquid oil to b) and
e) optionally apply shear.

7. The process according to claim 6 wherein in step b) the other food ingredients are selected from the group consisting of sweeteners, spices, herbs, salt, bulking agents, fat composition and a combination of two or more thereof.

8. The process according to claim 6, wherein the obtained food product is a filling that is applied to a first biscuit, cookie, cracker or wafer and optionally a second biscuit, cookie, cracker or wafer on top of the filling is added to make a filled biscuit, cookie, cracker or wafer.

9. The process of claim 8, wherein the steps of applying filling to a first biscuit, cookie, cracker or wafer and optionally adding a second biscuit, cookie, cracker or wafer on top of the filling is repeated several times, to have one or more biscuit, cookie, cracker or wafer layers and fillings in between a top and bottom biscuit, cookie, cracker or wafer.

10. The process of claim 7, wherein sweeteners, bulking agents, powdered fat and optionally liquid oil and/or fat composition and/or other food ingredients are tempered at a temperature in the range of 10 to 60° C., and the process steps are carried out at this temper temperature.

11. A process for making a biscuit filling, wafer filling, pie cookie filling, cracker filling or cookie filling comprising:
a) mixing of food ingredients other than fat and liquid oil, and/or optionally a fat composition and/or liquid oil
b) applying shear to mixture of step a); and
c) add optionally other food ingredients other than liquid oil to a) and apply shear
d) add a powdered fat to c) and apply shear
e) Repeat c) as needed

12. The process of claim 1, wherein the food product comprises a content of fat of from 2% by weight to 80% by weight.

13. The process of any of claim 11, wherein the food product comprises a content of fat of from 2% by weight to 80% by weight.
